(19) United States
(12) Patent Application Publication
(10) Pub. No.: US 2010/0101733 A1
(43) Pub. Date: Apr. 29, 2010

(54) DESKTOP DOUBLE-SIDED ADHESIVE TAPE DISPENSER

(76) Inventors: Hsiu-Man Yu Chen, Tan Tzu Township (TW); Judson C. Berg, Bedford, NY (US)

Correspondence Address: SINORICA, LLC, 2275 Research Blvd., Suite 500, ROCKVILLE, MD, 20850, US

(21) Appl. No.: 12/257,458

(22) Filed: Oct. 24, 2008

(51) Int. Cl. B29C 65/50

(52) U.S. Cl. 156/459

(57) ABSTRACT

A desktop double-sided adhesive tape dispenser includes a main body formed with a lengthwise opening and fixed inside with a fundamental plate provided with a guide rail at a location of the lengthwise opening. The fundamental plate is disposed with a tape-winding unit containing a first fixing shaft and a second fixing shaft positioned side by side. The first fixing shaft is pivotally fitted with a withdrawing gear having a withdrawing reel pivotally fitted thereon, while the second fixing shaft is pivotally fitted with a driving gear engaged with the withdrawing gear and pivotally fitted with a driving reel having a double-sided adhesive tape fitted thereon. Further, the fundamental plate is disposed with a tape-conveying wheel in front of the guide rail. The double-sided adhesive tape dispenser can be placed on a desktop for use, needless to be held with hands.

### BACKGROUND OF THE INVENTION

1. Field of the Invention

This invention relates to a desktop double-sided adhesive tape dispenser.

2. Description of the Prior Art

Generally, when double-sided adhesive is to be applied to soft fabric or a soft article, it is necessary to pull straight and even up the soft article first so that the double-sided adhesive can be tidily and smoothly stuck to the surface of the article. When employing a conventional double-sided adhesive tape dispenser, a user has to hold the adhesive tape dispenser with one hand and press an article with the other hand to have the double-sided adhesive stuck to the surface of the article, inconvenient in use and it is hard to have the double-sided adhesive tidily and smoothly stuck to an article.

### SUMMARY OF THE INVENTION

This invention is devised to offer a desktop double-sided adhesive tape dispenser, including a main body with a long opening, a fundamental plate, a tape-winding unit and a tape cutter. The fundamental plate assembled in the main body is provided with a guide rail at a location of the opening of the main body, and the guide rail has one long side extended upward and formed with a stop member. The tape-winding unit is installed on the fundamental plate, consisting of a first fixing shaft and a second fixing shaft arranged side by side. The first fixing shaft is pivotally fitted with a withdrawing gear having a withdrawing reel fitted thereon, while the second fixing shaft is pivotally fitted thereon with a driving gear mutually engaged with the withdrawing gear and pivotally fitted with a driving reel having a double-sided adhesive tape fitted thereon. Further, the fundamental plate is disposed with a tape-conveying wheel positioned in front of the guide rail. By so designing, the double-sided adhesive tape dispenser of this invention can be placed on a desktop for use, needless to be held with hands. In addition, the guide rail of the fundamental plate enables the double-sided adhesive to be conveniently and tidily stuck to the surface of an article.

### BRIEF DESCRIPTION OF DRAWINGS

This invention will be better understood by referring to the accompanying drawings, wherein:

FIG. 1 is an exploded perspective view of a desktop double-sided adhesive tape dispenser in the present invention;

FIG. 2 is a partial perspective view of the desktop double-sided adhesive tape dispenser in the present invention; and

FIG. 3 is perspective view of the desktop double-sided adhesive tape dispenser in a using condition in the present invention.

### DETAILED DESCRIPTION OF THE PREFERRED EMBODIMENT

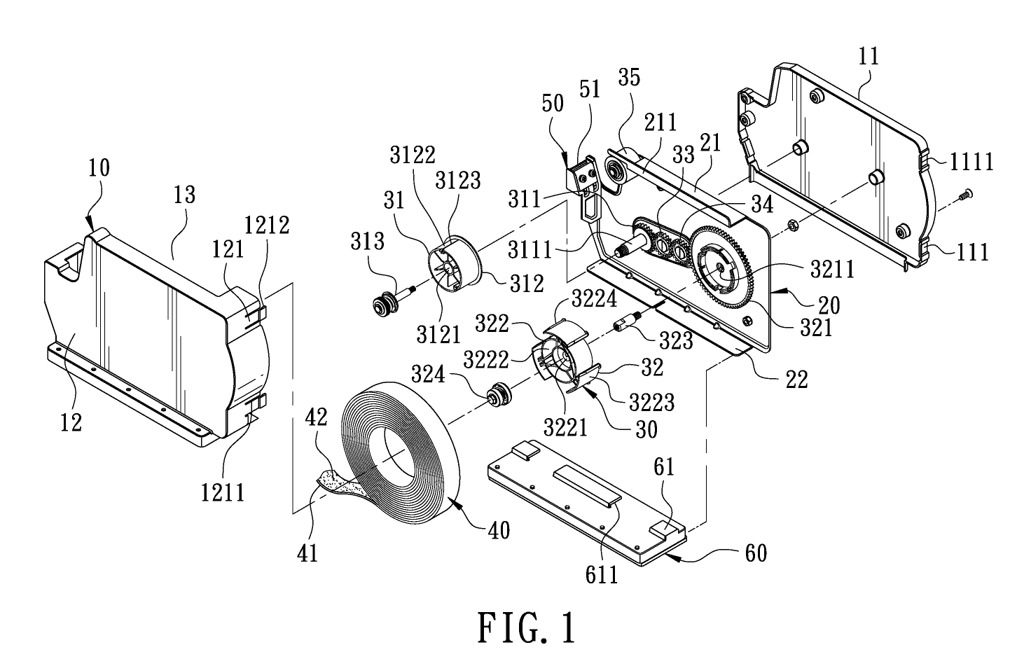

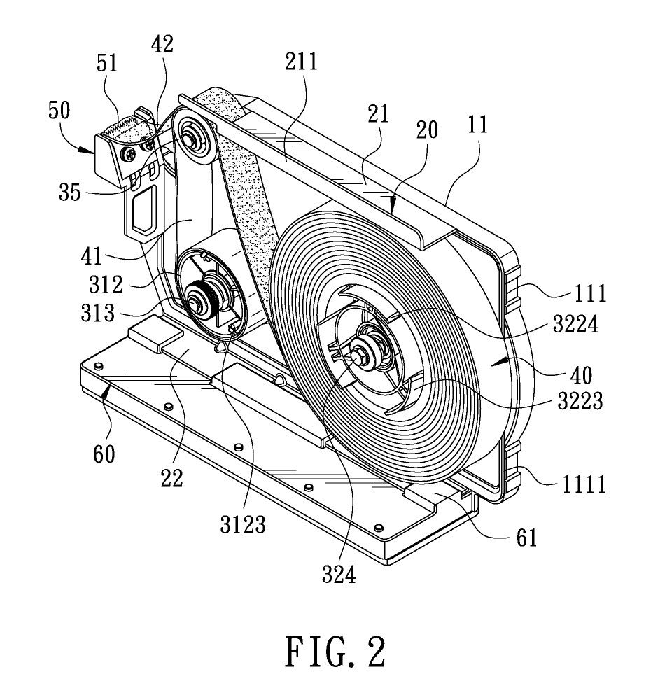

A preferred embodiment of a desktop double-sided adhesive tape dispenser in the present invention, as shown in FIGS. 1 and 2, includes a main body 10, a fundamental plate 20, a tape-winding unit 30, a double-sided adhesive tape 40, a tape cutter 50 and a weight 60 as main components combined together.

The main body 10 consists of a first half shell 11 and a second half shell 12 combined together.

The first half shell 11 has the opposite lateral sides of its outer peripheral wall provided with three combining recesses 111 dented inward diametrically, having the upper edge adjacent to its open side extended outward diametrically and formed with an engage edge 1111.

The second half shell 12 has the opposite lateral sides of its outer periphery disposed with three engage members 121 respectively corresponding with the three combining recesses 111 of the first half shell 11. The engage members 121 are rectangular plates respectively extending outward axially toward the open side along the outer periphery of the second half shell 12, and each engage member 121 has its opposite sides respectively cut with an elongate notch 1211 to enable the engage member 121 to produce elastic engagement effect. Further, each engage member 121 has its front edge protruding inward diametrically to form a projecting edge 1212 to be restrictedly engaged with the engage edge 1111 of the first half shell 11, and a common lengthwise opening 13 is defined by the upper side of the first and the second half shell 11 and 12 after both the first and the second half shell 11 and 12 are put together.

The fundamental plate 20 threadably fixed with the first half shell 11 is provided with a lengthwise guide rail 21 at a location matching with the opening 13 and somewhat parallel to the upper level of the opening 13. The guide rail 21 has one long side extended upward vertically and formed with a stop member 211, and the fundamental plate 20 has its lower side fixed with a long insert plate 22 extending outward transversely toward one side of the second half shell 12.

The tape-winding unit 30 is installed at the inner side of the fundamental plate 20 and positioned between the guide rail 21 and the insert plate 22. The tape-winding unit 30 consists of a first fixing shaft 313 and a second fixing shaft 323 arranged side by side, a withdrawing member 31, a tape-driving member 32, a first idle wheel 33, a second idle wheel 34 and a tape-conveying wheel 35.

The withdrawing member 31 contains a withdrawing gear 311 having its center extended upward axially and formed with a hollow bushing 3111 pivotally fitted thereon with a withdrawing reel 312 bored with a circular through hole 3121 in the center. The through hole 3121 of the withdrawing reel 312 has its outer wall extended outward and connected with a circular circumferential wall 3122 having its opposite sides axially cut with two lengthwise engage notches 3123. The first fixing shaft 313 is inserted through both the through hole 3121 of the withdrawing reel 312 and the bushing 3111 and then threadably secured at the left inner side of the fundamental plate 20.

The tape-driving member 32 is provided with a driving gear 321 with a central through hole 3211. A driving reel 322 is fitted on a sidewall of the driving gear 321 and formed with a central through hole 3221 having its outer wall extended outward diametrically and connected with a circular circumferential wall 3222, which is disposed thereon with three fixing plates 3223 spaced apart equidistantly and facing outward diametrically. Each fixing plate 3223 has its opposite lateral sides respectively formed with an engage edge 3224 protruding outward diametrically. The second fixing shaft 323 is inserted through both the through hole 3211 of the driving gear 321 and the through hole 3221 of the driving reel 322, having its inner end threadably secured at the right inner side of the fundamental plate 20 and its outer end fixed with a screw 324, letting the driving gear 321 and the driving reel 322 respectively positioned therebetween. A first idle wheel 33 and a second idle wheel 34 pivotally fixed on the fundamental plate 20 are located between the withdrawing gear 311 and the driving gear 321 and engaged with one another. The tape-conveying wheel 35 is positioned in front of the guide rail 21 and pivotally fixed on the fundamental plate 20, with its upper edge generally flush with the guide rail 21.

The double-sided adhesive tape 40 is to be fitted around the outer side of the fixing plates 3223 of the driving reel 322 and closely engaged with the engage edges 3224 of the fixing plates 3223, containing a separable paper 41 stuck thereon with double-side adhesive 42.

The tape cutter 50 is threadably fixed on the fundamental plate 20 and positioned in front of the tape-conveying wheel 35, provided with a serrated edge 51 for cutting off the double-side adhesive 42. The double-side adhesive tape 40 goes through the underside of the guide rail 21 and then passes on the topside of the tape-conveying wheel 35 to have the separable paper 41 and the double-sided adhesive 42 separated from each other. Simultaneously, the separable paper 41 is actuated to pass on the withdrawing reel 312 adjacent to one side of the driving reel 322 and then stuck in the engage notches 3123 of the withdrawing reel 312, and meanwhile the double-side adhesive 42 will adhere to the tape cutter 50.

The weight 60 preset in heaviness is assembled under the fundamental plate 20 and has its topside disposed with three engage plates 61 spaced apart for tallying with the insert plate 22 of the fundamental plate 20. The three engage plates 61 are respectively bent to one side to form three engage grooves 611 respectively defined by the engage plate 61 and the topside of weight 60 for the insert plate 22 of the fundamental plate 20 to be fitted therein to restrictedly position the fundamental plate 20 on the weighted block 60.

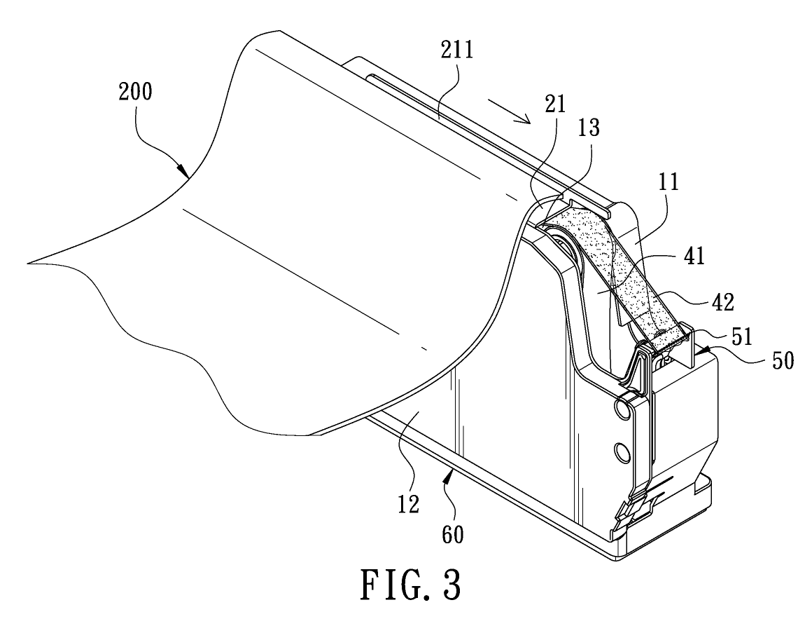

In using, referring to FIGS. 2 and 3, firstly, the double-sided adhesive tape dispenser is placed upright on a desktop, and an article 200 to be stuck with the double-sided adhesive 42 is pulled straight and placed on the guide rail 21 and then moved forward to tidily contact with the stop member 211. Subsequently, the article 200 is pulled transversely toward the tape-conveying wheel 35 to enable the double-sided adhesive 42 to be tidily stuck to the underside of the article 200, and meanwhile the separable paper 41 without adhesive 42 stuck thereon will be wound up by the withdrawing reel 312. After the article 200 is completely stuck with the double-sided adhesive 42 at locations required, simply have the double-sided adhesive 42 cut off by the serrated edge 51 of the tape cutter 50. By so designing, the double-sided adhesive tape dispenser of this invention can be placed on a desktop for use, needless to be held with hands, and hence an article 200 to be stuck with double-sided adhesive can be pulled straight and evened up with the help of two hands. In addition, the guide rail 21 of the fundamental plate 20 enables the double-sided adhesive 42 to be stuck to an article conveniently and tidily.

While the preferred embodiment of the invention has been described above, it will be recognized and understood that various modifications may be made therein and the appended claims are intended to cover all such modifications that may fall within the spirit and scope on the invention.

I claim:

1. A desktop double-sided adhesive tape dispenser comprising:
a main body having its topside formed with a long opening;
a fundamental plate vertically assembled in said main body, said fundamental plate transversely provided with a lengthwise guide rail at a location corresponding with said opening of said main body, said guide rail having one long side extended upward vertically and formed with a stop member; and
a tape-winding unit installed on said fundamental plate, said tape-winding unit at least consisting of a first fixing shaft and a second fixing shaft arranged side by side, said first fixing shaft pivotally fitted with a withdrawing gear, said withdrawing gear pivotally fitted thereon with a withdrawing reel, said second fixing shaft pivotally fitted thereon with a driving gear engaged with said withdrawing gear, said driving gear pivotally fitted with a driving real, said driving reel having a double-sided adhesive tape fitted thereon, said fundamental plate pivotal y disposed with a tape-conveying wheel positioned in front of said guide rail.

2. The desktop double-sided adhesive tape dispenser as claimed in claim 1, wherein said tape-winding unit contains two idle gears positioned between said withdrawing gear and said driving gear.

3. The desktop double-sided adhesive tape dispenser as claimed in claim 1, wherein said guide rail is generally flush with upper edge of said tape-conveying wheel.

4. The desktop double-sided adhesive tape dispenser as claimed in claim 1, wherein a weight preset in heaviness is assembled under said fundamental plate.

5. The desktop double-sided adhesive tape dispenser as claimed in claim 1, wherein said main body is composed of a first half shell and a second half shell combined together, and said fundamental plate is assembled on said first half shell, said first half shell having its outer periphery provided with three combining recesses, said second half shell disposed with engage members corresponding with said combining recesses, said engage members respectively engaged with said combining recesses.

6. The desktop double-sided adhesive tape dispenser as claimed in claim 1, wherein said fundamental plate is provided with a tape cutter positioned in front of said tape-conveying wheel.
